(19) United States
(12) Patent Application Publication
(10) Pub. No.: US 2009/0198716 A1
(43) Pub. Date: Aug. 6, 2009

(54) METHOD OF BUILDING A COMPRESSION DICTIONARY DURING DATA POPULATING OPERATIONS PROCESSING

(76) Inventors: Shawn Allen Howarth, Parkhill (CA); Leo Tat Man Lau, Thomhill (CA); William R. Minor, Markham (CA); Billy Phu, Scarborough (CA); Aleksandrs Santars, Toronto (CA); Michael Jeffrey Winer, Markham (CA)

Correspondence Address: LAW OFFICE OF DONALD L. WENSKAY, P.O. Box 7206, Rancho Santa Fe, CA, 92067, US

(21) Appl. No.: 12/025,602

(22) Filed: Feb. 4, 2008

(51) Int. Cl. G06F 17/30

(52) U.S. Cl. 707/101; 707/E17.002

(57) ABSTRACT

A system and method for synchronously building a Ziv-Lempel dictionary during online insert processing. In one embodiment the invention includes a method for processing information that includes the steps of initiating a process for adding data to a data object including a table and determining if a predetermined condition exists for triggering the creation of a compression dictionary. The compression dictionary is then created if the predetermined condition exists. Once created, the dictionary may then be inserted into the data object.

### FIELD OF INVENTION

The present invention generally relates to computer implemented information management systems, and particularly to systems and methods for building a compression dictionary which can be used for data compression.

### BACKGROUND

Data compression has traditionally been implemented as a host software task. Recently, there has been a trend toward implementing hardware data compression, especially within data storage subsystems and devices. This strategy reduces the host workload and increases effective storage capacity and transfer rate. Increases in VLSI density and continuing improvement of sophisticated data compression procedures that automatically adapt to different data have encouraged this trend.

Data compression procedures have a number of challenges including the difficulties with updating adaptive dictionaries and the processor overhead associated with developing and adapting such a dictionary over time. Practitioners in the art have proposed powerful adaptive compression procedures, such as the Ziv-Lempel adaptive parse-tree, for compressing data and for evolving the code dictionary responsive to data characteristics. See Ziv, et al., “A Universal Algorithm for Sequential Data Compression,” IEEE Trans. Info. Theory, IT-23, No. 3, pp. 337-343, May 1977, which is incorporated by reference.

The basic Ziv-Lempel encoder has a code dictionary in which each source sequence entry has an associated index (code) number. Initially, the dictionary contains only the null-string root and perhaps the basic source alphabet. During the source data encoding process, new dictionary entries are formed by appending single source symbols to existing dictionary entries whenever the new entry is encountered in the source data stream. The dictionary can be considered as a search tree or parse-tree of linked nodes, which form path representing source symbol sequences making up an “extended” source alphabet. Each node within the parse-tree terminates a source symbol sequence that begins at the null-string root node of the tree. The source data stream is compressed by first recognizing sequences of source symbols in the uncompressed input data that correspond to nodes in the parse-tree and then transmitting the index (code symbol) of a memory location corresponding to the matched node. A decoder dictionary is typically constructed from the parse-tree to recover the compressed source sequence in its original form. The Ziv-Lempel parse-tree continuously grows during the encoding process as additional and increasingly lengthier sequences of source symbols are identified in the source data stream, thereby both adapting to the input data character and steadily improving the compression ratio.

The ideal Ziv-Lempel compression procedure is difficult to implement in practice because it requires an indefinitely large memory to store the parse-tree. Practitioners have introduced data structures designed to ease this problem, including the well-known Ziv-Lempel technique. Terry A. Welch (“A Technique for Higher Performance Data Compression” IEEE Computer, Vol. 17, No. 6, pp. 8-19, June 1984) discusses data structures that improve the efficiency of the basic Ziv-Lempel technique, trading off compression efficiency for simplified implementation. Also, U.S. Pat. No. 4,814,746, to Victor S. Miller, et al. discloses a variation on the Ziv-Lempel data compression method that improves compression efficiency using a fixed parse-tree size. However, the Miller, et al method employs a hash table that requires significant memory and processing time, thereby negating much of the speed advantage sought with hardware-based dictionaries. The related art is generally documented by other practitioners and can be clearly understood with reference to Willard Eastman's disclosure in U.S. Pat. No. 5,087,913, which extends his earlier work disclosed in U.S. Pat. No. 4,464,650, and Terry Welch's disclosure in U.S. Pat. No. 4,558,302, all of which are entirely incorporated herein by this reference.

A fundamental problem presented by hardware-based compression systems is how to best exploit the speed advantage of hardware encoders and decoders while enjoying the compression efficiency offered by the Ziv-Lempel class of dictionaries. Also, the Ziv-Lempel technique generally relies on continuing adaptation of the parse-tree responsive to an incoming source data stream, so the resulting dictionary must be continuously updated by software processes, a wasteful procedure for hardware-based systems. Several practitioners have also considered the problem of poor compression efficiency during the early tree-building process. The Ziv-Lempel parse-tree is initialized either with the null-string root node alone or with the root node and a single set of source alphabet child-nodes. The initial parse-tree has only this inefficient dictionary with which to encode the early portion of the input data stream.

Another problem presented by implementation of the Ziv-Lempel parse-tree is memory space limitations. In the above-cited patent, Miller, et al. discusses the use of a replacement procedure that updates the dictionary responsive to recent samples of the source data stream without overflowing a fixed dictionary size. Implicit in such a replacement procedure is the understanding that both the encoder and decoder dictionaries are updated simultaneously in accordance with the modified parse-tree and that any data already encoded by the deleted entry is no longer in existence, having already been decoded. This is suitably assumed in a communication channel but is not likely in a database storage system. Also, maintaining the parse-tree and dictionary data structures can be difficult when nodes and strings are to be deleted using the LRU strategy.

To address some of these concerns, in U.S. Pat. No. 5,412,834 (incorporated herein by reference) Chung-Chia Chang et al. disclose a method for using a version of the Ziv-Lempel compression procedure that is applicable for use in a hardware system for compressing databases of the type employed by database systems such as the International Business Machines Corporation Daabase2 (DB2). This method creates a Ziv-Lempel dictionary and then freezes the tree to form a static dictionary for all of the data compression. The static Ziv-Lempel dictionary can then be readily stored for use in a hardware-based compression apparatus. This static dictionary is built with reference to the peculiar data-base stream reflecting actual data table characteristics and is then frozen for use in compressing data tables from the same database. By building and freezing the static Ziv-Lempel dictionary required for the encoding and decoding procedures before compressing any data, the entire static dictionary is available at the beginning of the data stream, thereby avoiding the well-known initial compression inefficiency of the Ziv-Lempel technique.

A dictionary build using the method disclosed in U.S. Pat. No. 5,412,834 may be triggered by either DB2 REORG or DB2 LOAD processing. The drawback of such a solution is that in order to take full advantage of the compression feature of DB2, the user must explicitly issue the REORG or LOAD command. This may require a reliance on external tools or applications.

Another problem with the method disclosed in U.S. Pat. No. 5,412,834 is that sampling completes once the dictionary tree has been successfully filled and hence there is not option for the user to control the amount of sampling if the dictionary tree is a fixed size. As a result, the user does not have control over the amount of data that is contributing to building the dictionary.

Accordingly, there is a need for systems and methods that can build a compression dictionary, such as the static Ziv-Lempel compression dictionary without any external action required on the part of the user. There is also a need for systems and methods for driving a compression dictionary build without relying on external tools or applications. Also, there is a need for a technique that allows a user to control the amount of data that contributes to the building of a compression dictionary.

### SUMMARY OF THE INVENTION

To overcome the limitations in the prior art briefly described above, the present invention provides a method, computer program product, and system for synchronously building a Ziv-Lempel compression dictionary during online insert processing.

In one embodiment of the present invention a method for processing information comprises: initiating a process for adding data to a data object including a table; determining if a predetermined condition exists for triggering the creation of a compression dictionary; creating the compression dictionary if the predetermined condition exists; and inserting the dictionary into the data object.

In another embodiment of the present invention, a method for creating a compression dictionary comprises: sampling data to be added to a database; validating the data based on validation conditions which include the amount of data sampled; and creating a compression dictionary only if the validation conditions are met.

In an additional embodiment of the present invention a system comprises: a database; a database populating component for adding data to the database; a sampling buffer sampling data from the database populating component; and a compression dictionary generating component generating a compression dictionary only when predetermined conditions exist, the predetermined conditions including the condition that the sampling buffer contains a minimum amount of data.

In another embodiment of the present invention, a computer program product comprises a computer usable medium having a computer readable program, wherein the computer readable program when executed on a computer causes the computer to: initiate a process for adding data to a data object including a table; determine if a predetermined condition exists for triggering the creation of a compression dictionary; create the compression dictionary if the predetermined condition exists; and insert the dictionary into the data object.

Various advantages and features of novelty, which characterize the present invention, are pointed out with particularity in the claims annexed hereto and form a part hereof. However, for a better understanding of the invention and its advantages, reference should be made to the accompanying descriptive matter together with the corresponding drawings which form a further part hereof, in which there are described and illustrated specific examples in accordance with the present invention.

### BRIEF DESCRIPTION OF THE DRAWINGS

The present invention is described in conjunction with the appended drawings, where like reference numbers denote the same element throughout the set of drawings:

FIG. 1 shows a flow chart of a process for triggering a dictionary build in accordance with an embodiment of the present invention;

FIG. 2 shows a flow chart of a process for record sampling in accordance with an embodiment of the present invention;

FIG. 3 shows a conceptual diagram of a sampling buffer containing three records in accordance with an embodiment of present invention;

FIG. 4 shows a flow chart of a process for synchronously building a Ziv-Lempel dictionary during data populating operations processing in accordance with an embodiment of the present invention; and

FIG. 5 shows a high level block diagram of an information processing system useful for implementing one embodiment of the present invention.

### DETAILED DESCRIPTION OF THE INVENTION

The present invention overcomes the problems associated with the prior art by teaching a system, computer program product, and method for synchronously building a Ziv-Lempel dictionary during online insert processing. In the following detailed description, numerous specific details are set forth in order to provide a thorough understanding of the present invention. Those skilled in the art will recognize, however, that the teachings contained herein may be applied to other embodiments and that the present invention may be practiced apart from these specific details. Accordingly, the present invention should not be limited to the embodiments shown, but is to be accorded the widest scope consistent with the principles and features described and claimed herein. The following description is presented to enable one of ordinary skill in the art to make and use the present invention and is provided in the context of a patent application and its requirements.

The invention addresses problems that may arise when building compression dictionaries. The present invention introduces a method to automatically build a compression dictionary, such as a Ziv-Lempel static compression dictionary, by any operation that may populate a database table object. In embodiments where the invention is applied to a DB2 system, these operations may include, but are not restricted to operations such as INSERT, LOAD, REDISTRIBUTE, and IMPORT processing. The present invention may be employed on future operations that have the ability to build a compression dictionary in such a fashion. This overall process is called Automatic Dictionary Creation (ADC).

ADC effectively reduces the administrative costs associated with database compression. The present invention also integrates the size of the table and/or the amount of data into the decision of when a dictionary will be built. Prior solutions to building a dictionary for DB2, such as the one taught in U.S. Pat. No. 5,412,384, triggered a dictionary build by either DB2 REORG or DB2 LOAD processing. The drawback of such a solution is that in order to take full advantage of the compression feature of DB2, the user must explicitly issue the REORG or LOAD command. The present invention integrates dictionary build into all data population operations, most importantly regular INSERT processing, thereby reducing any need for the user to explicitly trigger a dictionary build which leads to future data compression.

With the present invention, dictionary build is integrated into the growth of, the data being compressed, such as the table data object. Therefore, as the table grows beyond a specified threshold, a dictionary will be built. An advantage to this approach is that a user will not be required to drive a dictionary build through any external action. The ability to build a dictionary will be inherited by any action that may drive an increase in the size of the table object. For example, in a DB2 system the table object may be a DAT object, such as INSERT, IMPORT and REDISTRIBUTE operations. There is no reliance on external tools or applications. Those skilled in the art will understand the concept of how a table may increase in size over time.

The present invention offers a number of advantages over prior art methods which require explicit user action in order to drive dictionary build. For example, in the present invention sampled records may be buffered prior to building the dictionary tree. A dictionary tree is built by sampling records in the table. By buffering this data prior to building the dictionary tree, the user has control over the amount of data that will contribute to building the dictionary. In prior methods, such as taught in U.S. Pat. No. 5,412,384, sampling completes once the dictionary tree has been successfully filled. However, there is no option for the user to control the amount of sampling if the dictionary tree is a fixed size. By controlling the amount of data that is buffered, the user has effectively controlled the amount of data contributing to building the dictionary. It will be appreciated that in some embodiments, a default buffer size may be employed and the dictionary build proceeds automatically.

Another advantage of the present invention is that dictionary validation may be based on the amount of data processed for sampling. Building the dictionary tree is triggered by the growth of the table object. However, the newly built dictionary will only be retained if the amount of data sampled meets the minimum sampling threshold requirements. Therefore, building and retaining a dictionary is a two-step process. In the prior art, the dictionary build would continue only once the dictionary tree was filled. There was no control on the amount of data required to build the dictionary. With the present invention, validating the dictionary may be based on the amount of data processed for sampling. This yields more control to the user in determining when the dictionary should be built. The invention may use a buffered approach to sampling wherein the record data is written to a special sampling buffer. In some embodiments of the invention, a buffer less approach may also be used in building the dictionary. However, it should be noted that the sampled data may be stored in various manners. A key feature of the invention is the fact that the dictionary is validated based on the amount of data processed for sampling.

Another advantage of the present invention is that LOAD INSERT will build a dictionary. The prior art, such as U.S. Pat. No. 5,412,384, teaches a method for building a dictionary during DB2 LOAD REPLACE processing, when replacing all the existing data in the table. In accordance with embodiments of the present invention a dictionary may be built when data is appended to the table and not only when replacing all the data in the table. For example, with the present invention, in a DB2 system, this may comprise a process where LOAD INSERT processing appends data to the table. This new functionality allows LOAD to build a dictionary, regardless of the LOAD method specified by the user.

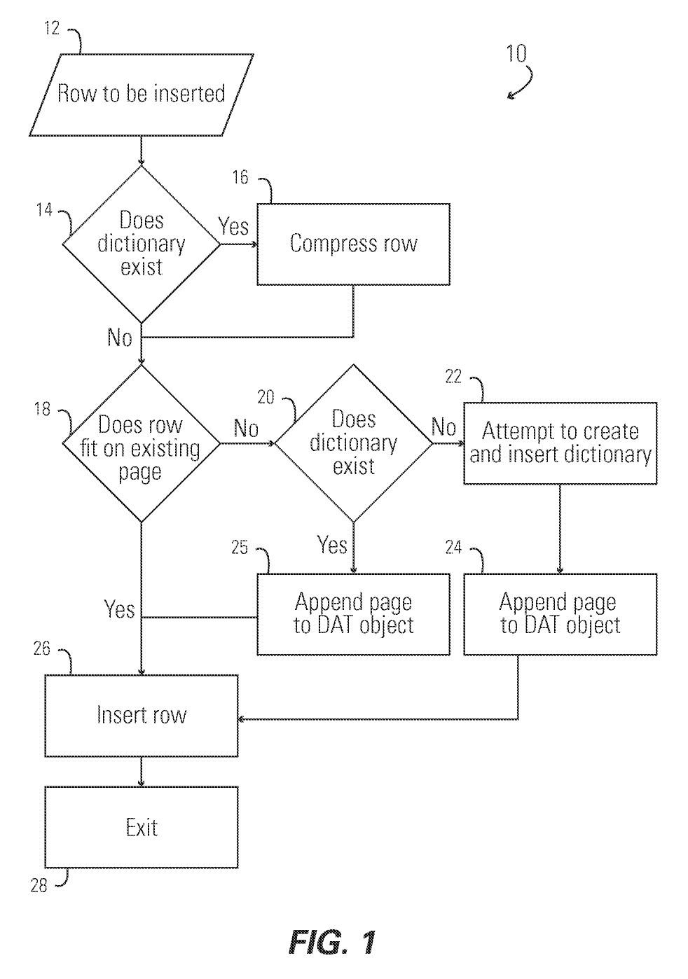

Referring now to FIGS. 1-5, the present invention includes a method for building a dictionary tree in a synchronous fashion for data population. In the embodiment shown, the data population methods used are DB2 IMPORT, INSERT, and REDISTRIBUTE. However, the invention may be applied to various other known data population processes as well as future data population techniques. In one embodiment, the present invention involves two main steps: 1) triggering a dictionary build and 2) record sampling for dictionary build.

In the first step, the process of building a dictionary tree is triggered by the growth of the table data object. A database level threshold defines the table size required to trigger a dictionary build. While this method describes the threshold at the database level, those skilled in the art will understand that the scope of this threshold may also be defined on the table or table space. This threshold is defined in bytes and translated to a page count in the table. As the table grows, the number of pages in that table will increase. It is this increase in the table object size that may trigger a dictionary build. As the table is extended, a check is performed to determine whether the object size is larger than the dictionary build threshold. If this is the case, a dictionary build is triggered.

Dictionary build will not proceed if a dictionary already exists. If this is the case, the record will be compressed and INSERT will continue to process as normal. FIG. 1 is a flow chart showing the overall process 10 of triggering a dictionary build, starting from step 12, the point at which a record (a row) is to be inserted into the table. In step 14, the process determines if a dictionary already exists. If a dictionary does exist, step 16 compresses the row using the existing compression dictionary.

If a dictionary does not exist, step 18 will determine if the row fits on an existing page. If it does not, step 20 will determine if a dictionary exists. This second check to see if a dictionary exists may be useful in online processes where there may be concurrent activity by another user building a dictionary. If step 20 determines that a dictionary does not exist, step 22 will attempt to create and insert a dictionary. Next, step 24 will append a page containing the dictionary to the data object and step 26 will insert the row.

If step 20 determined that a dictionary already exists, step 25 will append a page containing the dictionary to the data object. Step 26 will then insert the row, whereupon the process 10 ends at step 28.

Data used to build the dictionary tree is buffered during the sampling phase. Buffer feedback is incorporated into the sampling process. This feedback controls the amount of data sampled by notifying the caller once the sampling buffer is full. If the sampling buffer is filled, the sampling process is aborted and a dictionary tree is built, based on the data in the buffer. The table will be scanned until either the sampling buffer is filled or the end of the table is reached.

The sampling buffer size is tunable, thereby allowing the user to effectively control the amount of data used in building the dictionary tree. Once the buffer is filled, or the table scan completes, a dictionary is built. It is possible this dictionary will not be retained. A second check validates that the amount of data in the sampling buffer indeed meets the minimum sampling threshold. Those skilled in the art will understand that sparse tables may have a large footprint on disk, yet very few records exist in the table. Therefore, triggering a dictionary build may be based on the table size, however the amount of data sampled must also be validated before retaining the dictionary

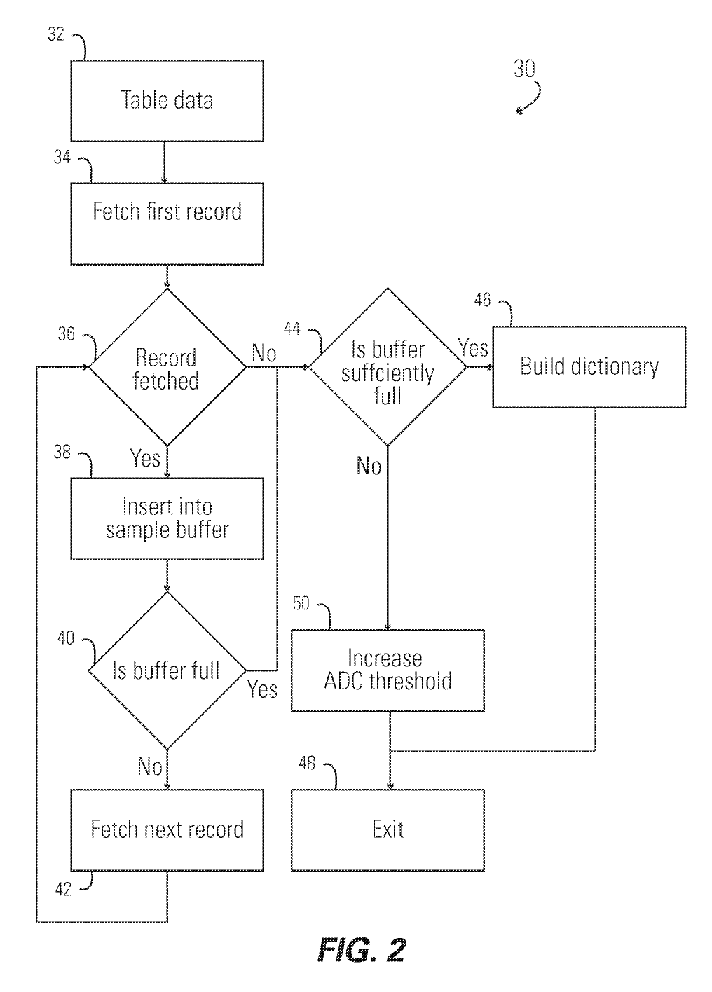

FIG. 2 is a flowchart of a sampling process 30 for record sampling in accordance with an embodiment of the invention. Step 32 obtains the table data and step 34 fetches the first record. The process 30 then determines if a record has been fetched in step 36. If the answer is yes, step 38 inserts the record into the sample buffer. The process 30 then determines, in step 40 whether the buffer is full. If the buffer is not full then step 42 fetches the next record and the process 30 returns to step 36 to ascertain whether another record has been fetched.

In those instances where step 36 determines that another record has not been fetched, or where step 40 determines that the buffer is full, the process 30 moves to step 44 which determines if the buffer is sufficiently full. That is, as discussed above, this step validates that the amount of data in the sampling buffer meets the minimum sampling threshold. If the buffer is sufficiently full, then step 46 builds a dictionary and the process ends at step 48. If instead, the buffer was not sufficiently full then step 50 will increase the Automatic Dictionary Creation (ADC) threshold. Note that the ADC threshold may be is some amount of memory. It will be appreciated by those skilled in the art that sparse tables may have a large footprint on disk, yet very few records may exist in the table. Therefore, triggering a dictionary build may be based on the table size; however, the amount of data sampled must also be validated before retaining the dictionary. An appropriate ADC threshold will insure that the dictionary is not built too late so that there will not be much compression, or that the dictionary is not built too soon, so that there will not be good compression. The process 30 will then end at step 48.

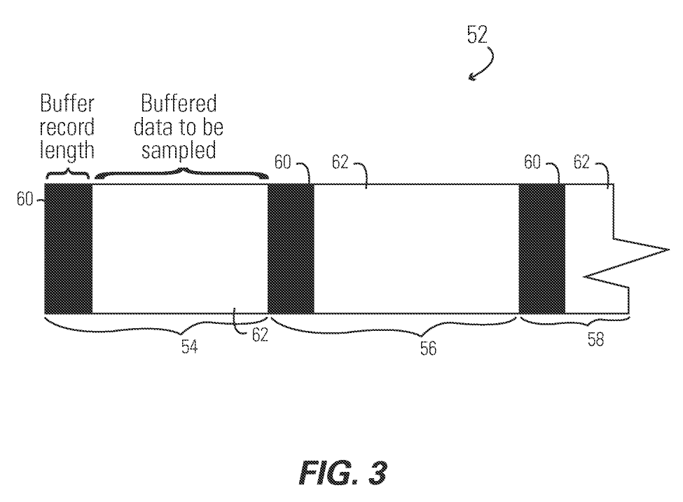

Data written to the sampling buffer contains two parts as illustrated in FIG. 3, which shows a conceptual diagram of the sampling buffer 52 containing the three records 54, 56, and 58 in accordance with an embodiment of the present invention. The first two bytes 60 of the data in a record store the buffer record length, followed by the number of bytes of data 62 representing what is to be sampled. While only three records 54, 56 and 58 are shown in FIG. 3, it will be appreciated that the sampling buffer 52 may contain any finite number of records chained together in this fashion.

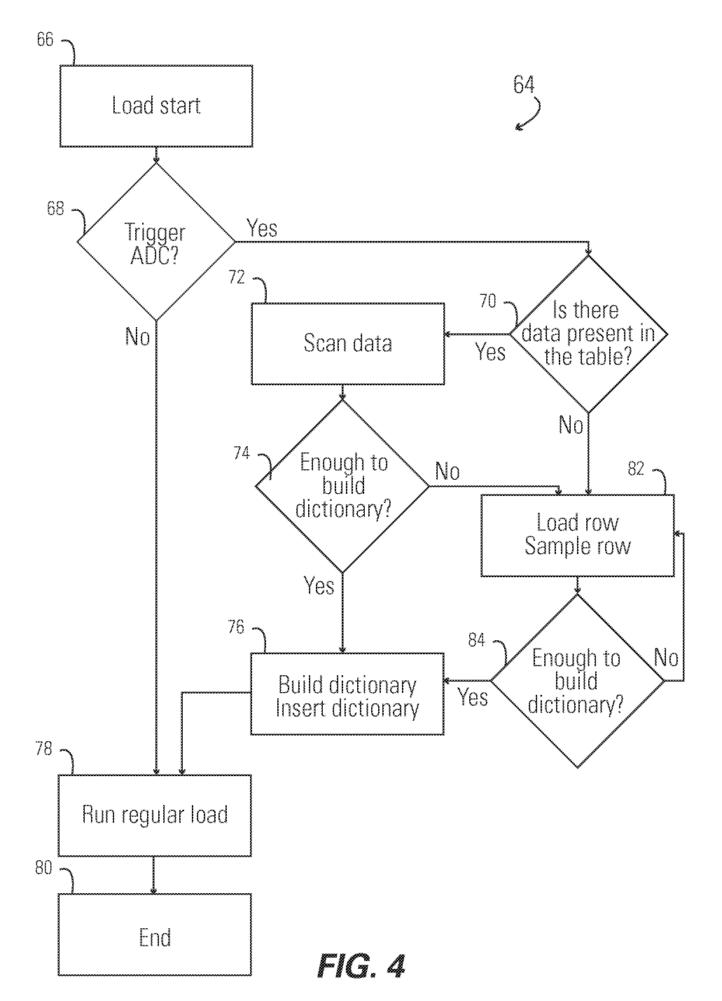

FIG. 4 shows a flow chart of a process 64 for building a compression dictionary. In one embodiment, the process 64 may be used to synchronously build a compression dictionary; however, those skilled in the art will appreciate that these teachings can be readily applied to a process for asynchronously building a compression dictionary. In some embodiments the process may be used to build a static Ziv-Lempel dictionary during online insert processing. In some embodiments this process 64 may be used to build a compression dictionary during a DB2 LOAD INSERT. It will be appreciated that in a LOAD REPLACE all existing data in the file is replaced, while in LOAD INSERT process appends data to the table. With this process 64, a dictionary is created based on how much data already exists in the table, and how much new data is to be loaded into the table. When building a dictionary for LOAD INSERT, a scan of the existing data is performed. If enough data was scanned to meet sampling threshold requirements, a dictionary will be built. If this is not the case, LOAD INSERT will continue to sample the records being loaded into the table.

In more detail, process 64 begins with step 66 which starts the load process. Step 68 then determines whether to trigger the ADC. If step 68 determines that ADC should be triggered, step 70 will determine if there is data present in the table. If there is, step 72 will scan the data and step 74 will determine if there is enough data to build a dictionary. If there is enough data, step 76 will build and insert the dictionary. A regular LOAD operation may then be run, as shown in step 78, and the process 64 will end, step 80.

If step 70 determined that data was not present in the table, or if step 74 determined that there was not enough data to build a dictionary, step 82 will load the row and sample the row. The process 64 will then determine if there now is enough data in the table to build a dictionary, in step 84.

From the above description, it can be seen that the present invention effectively reduces the administrative costs associated with database compression. The present invention also integrates the size of the table and/or the amount of data into the decision of when a dictionary will be built. While the embodiment above described the automatic dictionary creation during online LOAD INSERT operation in a DB2 system, it will be appreciated that the above teachings may be readily adapted to IMPORT, REDISTRIBUTE and possibly other data population techniques, as well as other types of database systems.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

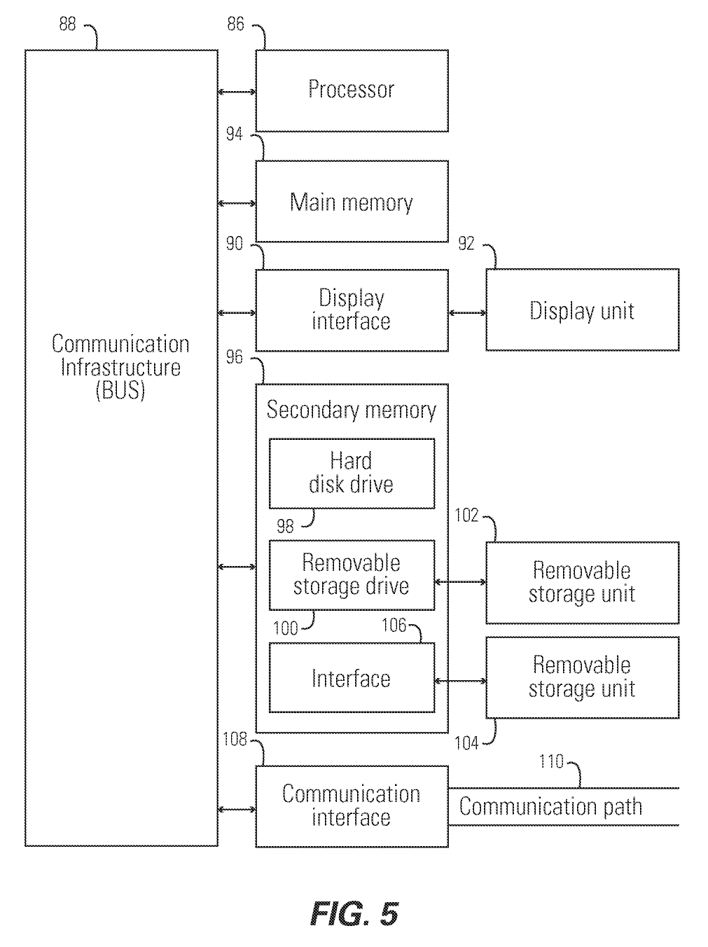

FIG. 5 is a high-level block diagram showing an information processing system useful for implementing one embodiment of the present invention. The computer system includes one or more processors, such as processor 86. The processor 86 is connected to a communication infrastructure 88 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 90 that forwards graphics, text, and other data from the communication infrastructure 88 (or from a frame buffer not shown) for display on a display unit 92. The computer system also includes a main memory 94, preferably random access memory (RAM), and may also include a secondary memory 96. The secondary memory 96 may include, for example, a hard disk drive 98 and/or a removable storage drive 100, representing a floppy disk drive, a magnetic tape drive, an optical disk drive, etc. The removable storage drive 100 reads from and/or writes to a removable storage unit 102 in a manner well known to those having ordinary skill in the art. Removable storage unit 102, represents a floppy disk, or a compact disc, or magnetic tape, or optical disk, etc., which is read by and written to by removable storage drive 100. As will be appreciated, the removable storage unit 102 includes a computer readable medium having stored therein computer software and/or data.

In alternative embodiments, the secondary memory 96 may include other similar means for allowing computer programs or other instructions to be loaded into the computer system. Such means may include, for example, a removable storage unit 104 and an interface 106. Examples of such may include a program cartridge and cartridge interface (such as that found in video game devices), a removable memory chip (such as an EPROM, or PROM) and associated socket, and other removable storage units 104 and interfaces 106 which allow software and data to be transferred from the removable storage unit 104 to the computer system.

The computer system may also include a communications interface 108. Communications interface 108 allows software and data to be transferred between the computer system and external devices. Examples of communications interface 108 may include a modem, a network interface (such as an Ethernet card), a communications port, a PCMCIA slot and card, etc. Software and data transferred via communications interface 108 are in the form of signals which may be, for example, electronic, electromagnetic, optical, or other signals capable of being received by communications interface 108. These signals are provided to communications interface 108 via a communications path (i.e., channel) 110. This channel 110 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 94 and secondary memory 96, removable storage drive 100 and a hard disk installed in hard disk drive 98.

Computer programs (also called computer control logic) are stored in main memory 94 and/or secondary memory 96. Computer programs may also be received via communications interface 108. Such computer programs, when executed, enable the computer system to perform the features of the present invention as discussed herein. In particular, the computer programs, when executed, enable the processor 86 to perform the features of the computer system. Accordingly, such computer programs represent controllers of the computer system.

In accordance with the present invention, we have disclosed systems and methods for synchronously building a Ziv-Lempel dictionary during online insert processing. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the preferred embodiments of the present invention have been described in detail, it will be understood that modifications and adaptations to the embodiments shown may occur to one of ordinary skill in the art without departing from the scope of the present invention as set forth in the following claims. Thus, the scope of this invention is to be construed according to the appended claims and not limited by the specific details disclosed in the exemplary embodiments.

We claim:

1. A method for processing information comprising:
initiating a process for adding data to a data object including a table;
determining if at least one predetermined condition exists for triggering the creation of a compression dictionary;
creating said compression dictionary if said least one predetermined condition exists; and
storing said dictionary, wherein said dictionary is available for use in data compressions.

2. The method of claim 1 wherein said determining if at least one predetermined condition exists comprises determining whether a threshold defining a predetermined table size has been exceeded.

3. The method of claim 2 wherein said determining whether a predetermined condition exists comprises determining the amount of data already existing in said table.

4. The method of claim 2 further comprising defining said threshold in bytes and translating said bytes into a page count in said table.

5. The method of claim 1 wherein said determining if a predetermined condition exists comprises determining if a compression dictionary already exists.

6. The method of claim 1 wherein said creating said compression dictionary comprises:
buffering said data added to said data object; and
using said buffered data to build a dictionary tree.

7. The method of claim 6 further comprising:
writing said data into a sampling buffer;
determining if said sampling buffer is either full or there is no more data to sample;
stopping said writing when said sampling buffer is full or if there is no more data to sample; and
building said dictionary tree after stopping said writing.

8. The method of claim 7 further comprising providing an external control over the size of said sampling buffer.

9. The method of claim 7 further comprising:
determining if the amount of data in said sampling buffer meets a minimum sampling threshold; and
creating said dictionary only if said minimum sampling threshold is met.

10. The method of claim 7 wherein said writing data into a sampling buffer comprises writing a record into said sampling buffer that includes a buffer record length portion and a sampled data portion.

11. The method of claim 1 wherein said data object is a table data object which is part of a database.

12. A method for creating a compression dictionary comprising:
sampling data added to a database;
validating said data based on validation conditions which include the amount of data sampled; and
creating a compression dictionary only if said validation conditions are met.

13. The method of claim 12 wherein said validating includes determining if said amount of data sampled data meets a validation threshold.

14. The method of claim 12 wherein said creating a compression dictionary further creates a compression dictionary only if a predetermined table size has been exceeded.

15. A system comprising:
a database;
a database populating component for adding data to said database;
a sampling buffer sampling data from said database populating component; and
a compression dictionary generating component generating a compression dictionary only when predetermined conditions exist, said predetermined conditions including the condition that said sampling buffer contains a minimum amount of data.

16. The system of claim 15 wherein said compression dictionary is a Ziv-Lempel compression dictionary.

17. The system of claim 15 wherein said data populating component adds and does not replace data in said database.

18. The system of claim 15 wherein said predetermined conditions include the condition that a compression dictionary does not already exist.

19. A computer program product comprising a computer usable medium having a computer readable program, wherein said computer readable program when executed on a computer causes said computer to:
initiate a process for adding data to a data object including a table;
determine if a predetermined condition exists for triggering the creation of a compression dictionary;
create said compression dictionary if said predetermined condition exists; and
using said dictionary to compress subsequent data.

20. The computer program product of claim 19 wherein said computer readable program further causes said computer to determine if a predetermined condition exists by determining whether a database level threshold defining a predetermined table size has been exceeded.
